(19) United States
(12) Patent Application Publication
(10) Pub. No.: US 2026/0061530 A1
(43) Pub. Date: Mar. 5, 2026

(54) Vertical Toothblock Pin for Configurable Block Assemblies

(71) Applicant: FIREBALL TOOL WORKS LLC, Spokane, WA (US)

(72) Inventors: Jason A. Marburger, Spokane, WA (US); Elliott Ian Wong, Alhambra, CA (US)

(73) Assignee: FIREBALL TOOL WORKS LLC, Spokane, WA (US)

(21) Appl. No.: 18/826,030

(22) Filed: Sep. 5, 2024

(51) Int. Cl. B23K 37/04

(52) U.S. Cl. CPC B23K 37/0452

(57) ABSTRACT

Configurable block assemblies are described. In an example, a configurable block assembly includes a block body with a toothed pin slot that includes an arrangement of teeth that extend inwardly to the toothed pin slot. The block assembly further includes a vertical toothblock pin that includes a multifaced pin collar. The multifaced pin collar has two or more pairs of substantially parallel sides, each pair having a unique tooth configuration. The tooth configurations of the pairs of sides of the multifaced pin collar are engageable with the arrangement of teeth of the toothed pin slot to enable variable positioning of the block assembly to achieve a variety of different working positions and working scenarios.

### BACKGROUND

Welders, carpenters, and personnel in general often desire to arrange workpieces at various positions to apply work to the workpieces, such as for designing, joining, finishing, etc. A welder, for instance, frequently desires to weld metal workpieces together at specific positions and angles. To assist personnel in arranging and holding workpieces in position, gridded tables have been developed that include grids of holes that are arranged to receive and hold various tools, such as pins, clamps, stop blocks, etc. Stop blocks, for instance, can be arranged on a grid table via pins that attempt to secure the stop blocks in various positions. Conventional pin and stop block implementations, however, have limited configurations. Further, precise placement of a stop block on a grid is difficult due to imprecision involved in a conventional pin and stop block assembly. Accordingly, it is often difficult and time consuming for users to controllably affix workpieces in a desired orientation or position.

### SUMMARY

Configurable block assemblies that use a vertical toothblock pin are described. Example block assemblies, e.g., configurable block assemblies, include a block body with a toothed pin slot that includes an arrangement of teeth that extend inwardly to the toothed pin slot. The block assembly further includes a vertical toothblock pin that includes a multifaced pin collar. The multifaced pin collar has two or more pairs of substantially parallel sides, each pair having a unique tooth configuration. The tooth configurations of the pairs of sides of the multifaced pin collar are engageable with the arrangement of teeth of the toothed pin slot to enable variable positioning of the block assembly to achieve a variety of different working scenarios.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures may be indicative of one or more entities and thus reference may be made interchangeably to single or plural forms of the entities in the discussion.

FIG. 1 depicts a view of an example block assembly in accordance with one or more implementations described herein.

FIG. 2 depicts a view of the configurable block assembly with the block body, vertical toothblock pin, and the pin disengaged from one another in accordance with one or more implementations.

FIG. 3a depicts a view of the vertical toothblock pin in accordance with one or more implementations.

FIG. 3b depicts a view of the vertical toothblock pin from above in accordance with one or more implementations.

FIG. 4 depicts an example scenario of engagement of the vertical toothblock pin with the toothed pin slot in accordance with one or more implementations.

FIGS. 5a and 5b depict an example usage scenario to use a configurable block assembly with the vertical toothblock pin in a first position in accordance with one or more implementations.

FIGS. 6a and 6b depict an example usage scenario to use a configurable block assembly with the vertical toothblock pin in a first position in accordance with one or more implementations.

FIG. 7a depicts a view of the vertical toothblock pin in which the multifaced pin collar includes eight sides in accordance with one or more implementations.

FIG. 7b depicts a top view of the octagonal vertical toothblock pin in accordance with one or more implementations.

FIG. 8a depicts an example of engagement of the first pair of parallel sides with the arrangement of teeth in accordance with one or more implementations.

FIG. 8b depicts an example of engagement of the second pair of parallel sides with the arrangement of teeth in accordance with one or more implementations.

FIG. 8c depicts an example of engagement of the third pair of parallel sides with the arrangement of teeth in accordance with one or more implementations.

FIG. 8d depicts an example of engagement of the fourth pair of parallel sides with the arrangement of teeth in accordance with one or more implementations.

FIGS. 9a, 9b, and 9c depict scenarios in which the toothed pin slot is included as part of a removable insert in accordance with one or more implementations.

FIG. 10 depicts an implementation of a block assembly that includes a variable width pin slot in accordance with one or more implementations.

FIG. 11 depicts a view of the block assembly with the block body, the first pin, and the pin disengaged from one another in accordance with one or more implementations.

FIG. 12 depicts a view of example toothed washers in accordance with one or more implementations.

### DETAILED DESCRIPTION

### Overview

Vertical toothblock pins for configurable block assemblies are described. In an example implementation a block assembly, e.g., a configurable block assembly, includes a block body and one or more vertical toothblock pins that are engageable with the block body. The block body, for instance, includes a toothed pin slot that extends along a longitudinal axis of the block body. The toothed pin slot extends through an interior of the block body from a top surface of the block body to a bottom surface of the block body. The toothed pin slot includes an arrangement of teeth that extend inwardly and substantially perpendicular to opposing sides of the toothed pin slot. Pins, bolts, screws, etc. can be inserted through the toothed pin slot to attach the block body to an adjacent surface, such as a gridded welding table.

To secure the block body to an adjacent surface in a particular position and/or at a discrete location, the block assembly includes a vertical toothblock pin that is insertable through the toothed pin slot. The vertical toothblock pin includes a multifaced pin collar that includes at least two pairs of substantially parallel sides. For instance, the multifaced pin collar has a cross section that is rectangular, hexagonal, octagonal, etc. Each pair of parallel sides can have a unique tooth configuration that is configured to engage with the arrangement of teeth of the toothed pin slot.

Consider an example in which the vertical toothblock pin has a rectangular cross section. A first pair of parallel sides of the vertical toothblock pin has a first tooth configuration that is configured to engage with the arrangement of teeth of the toothed pin slot. The arrangement of teeth, for instance, has a tooth spacing defined by a distance between corresponding points on adjacent teeth. In this example, the tooth spacing of the arrangement of teeth is ⅛ of an inch. Accordingly, the first tooth configuration includes one or more teeth configured to engage with the teeth of the arrangement of teeth to position the block body on an adjacent surface at increments of ⅛ of an inch.

The second pair of parallel sides has a second tooth configuration that is also configured to engage with the arrangement of teeth. For instance, the second tooth configuration includes one or more teeth that are dimensioned to engage with the tooth spacing of the arrangement of teeth. However, in this example the second tooth configuration is located an offset distance from a center of the vertical toothblock pin relative to the first tooth configuration. For instance, the second tooth configuration enables positioning of the block body on the adjacent surface at increments of ⅛ of an inch, however such positions are offset from the positions attainable by the first tooth configuration by 1/16 of an inch. Accordingly, the techniques described herein, such as via engagement of different pairs of parallel sides of the vertical toothblock pin with the arrangement of teeth, are usable to position the configurable block assembly at increments with finer resolution than the tooth spacing of the arrangement of teeth would otherwise permit.

In at least one embodiment of a configurable block assembly, the block body includes a variable width pin slot. The variable width pin slot includes a first region of a first width and a second region of a second width that includes an arrangement of teeth. The arrangement of teeth extends inwardly from opposing sides of the variable width pin slot.

In this embodiment, the configurable block assembly further includes a toothed washer that is dimensioned to coincide with the second region of the variable width pin slot. For instance, the toothed washer includes an outer surface that includes a tooth configuration and an inner surface defined by an aperture. The tooth configuration, for instance, includes teeth located on opposite sides of the outer surface and is configured to engage with the arrangement of teeth of the variable width pin slot.

In various examples, the configurable block assembly further includes a vertical pin dimensioned to coincide with the aperture of the toothed washer. The configurable block assembly can further include one or more vertical pins dimensioned to coincide with the first region of the variable width pin slot. For instance, one or more vertical pins can be inserted through the toothed washer and/or the first region of the variable width pin slot to attach the block body to an adjacent surface. In at least one example, the toothed washer includes an additional tooth configuration that includes teeth located on opposite sides of the outer surface. The additional tooth configuration, for instance, is configurable to position the toothed washer at offset distances within the variable width pin slot relative to positions attainable using the tooth configuration.

Accordingly, the described vertical toothblock pin, toothed washer, and configurable block assemblies provide for a multitude of different block configurations and workpiece arrangements not provided by conventional tools for aligning workpieces. In the following discussion, example block assemblies are described that may employ the techniques described herein. Example scenarios are also described in which the example block assemblies are utilized to align example workpieces. The example block assemblies are not limited to performance of the example scenarios.

### Configurable Block Assemblies

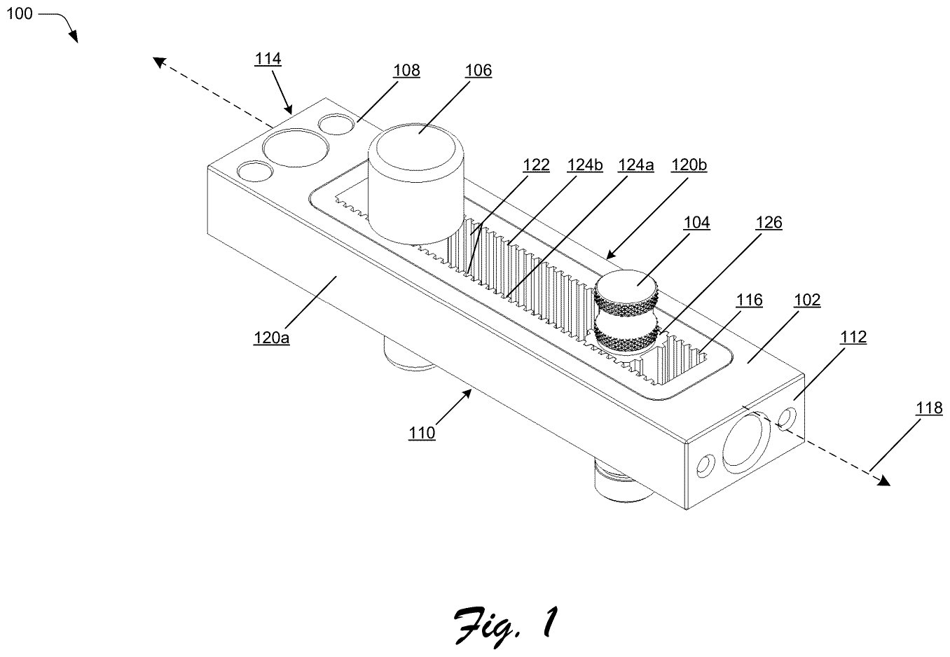

FIGS. 1-12 depict various attributes of example configurable block assemblies that are operable to employ techniques described herein. FIG. 1 depicts a view of an example block assembly 100 in accordance with one or more implementations described herein. In the illustrated example, the block assembly 100, e.g., a configurable block assembly, includes a block body 102, a vertical toothblock pin 104, and a pin 106 engaged with one another.

The block body 102 includes a top surface 108, a bottom surface 110, a front surface 112, and a rear surface 114. The block body 102 further includes a toothed pin slot 116 formed at least partially along the top surface 108 that extends through an interior of the block body 102 to the bottom surface 110. The toothed pin slot 116, for instance, forms an extended slot extending along a longitudinal axis 118 of the block body 102. Pins, bolts, screws, etc., such as the vertical toothblock pin 104 and/or the pin 106, can be placed through the toothed pin slot 116 to secure the block body to an adjacent surface, such as a gridded work surface, e.g., a welding table. The block body 102 further includes various surfaces that can be used for workpiece and/or tool arrangement including but not limited to the top surface 108, the front surface 112, the rear surface 114, a side surface 120a, and a side surface 120b.

While in the illustrated example, the front surface 112 and the rear surface 114 are depicted as flat (e.g., perpendicular to the longitudinal axis 118 of the block body 102) a variety of configurations and/or shapes of the front surface 112 and/or the rear surface 114 are considered. In some examples, the front surface 112 and/or the rear surface 114 include one or more angled surfaces, such as a “U-shaped” configuration. By way of example, the rear surface 114 includes a face surface perpendicular to the longitudinal axis 118, as well as a first angled surface that is angled relative to the side surface 120a and the face surface and a second angled surface that is angled relative to the side surface 120b and the face surface. For instance, the first angled surface intersects the side surface 120a at an acute angle (e.g., 15, 30, 45, or 60 degrees) and the second angled surface intersects the side surface 120b at an acute angle, e.g., 15, 30, 45, or 60 degrees.

This is by way of example and not limitation, and the front surface 112 and/or the rear surface 114 can include a variety of configurations. For instance, the front surface 112 and/or the rear surface 114 can include one or more of a V-shaped configuration, a tapered configuration, a wedge shape, an L-shape, or a polygonal face with any suitable number of angled faces. In some examples, the front surface 112 and/or the rear surface 114 includes one or more ridges and/or grooves such as to increase contact adhesion with a workpiece. In this way, the differently configured surfaces of the front surface 112 and/or the rear surface 114 enable workpieces to be positioned at various angles, orientations, and/or positions relative to one another.

The toothed pin slot 116 further includes an arrangement of teeth 122 that extend inwardly to the toothed pin slot 116. For instance, in the illustrated example the arrangement of teeth 122 includes a first toothed surface 124a and a second toothed surface 124b. In this example, the first toothed surface 124a and the second toothed surface 124b are disposed on opposing internal surfaces of the toothed pin slot 116 and are coplanar to the side surface 120a and the side surface 120b. The first toothed surface 124a, for instance, is proximal to the side surface 120a (e.g., closer to the side surface 120a than the side surface 120b) while the second toothed surface 124b is proximal to the side surface 120b, e.g., closer to the side surface 120b than the side surface 120a. As further described in more detail below, the vertical toothblock pin 104 includes a multifaced pin collar 126 that includes multiple faces configured to engage with the arrangement of teeth 122.

In the illustrated example, the arrangement of teeth 122 has a uniform spacing, e.g., a tooth spacing defined by a distance between corresponding points on adjacent teeth is consistent. For instance, teeth are positioned at equal intervals, such as spaced ⅛ of an inch apart along the first toothed surface 124a and/or the second toothed surface 124b. This is by way of example and not limitation, and a variety of tooth spacings and tooth configurations are considered.

In some examples, the arrangement of teeth 122 has a non-uniform tooth spacing such that teeth are positioned at varying intervals along the first toothed surface 124a and/or the second toothed surface 124b. For instance, teeth may be positioned with alternating and/or sequential gaps (e.g., valleys) between adjacent teeth, such as with alternating 4 mm and 6 mm gaps. In at least one example, the arrangement of teeth 122 includes a graduated spacing such as teeth that are positioned progressively closer or further apart along a length of the first toothed surface 124a and/or the second toothed surface 124b. For example, the arrangement of teeth 122 includes teeth starting 10 mm apart and gradually decreasing to 2 mm apart, which allows for variable degrees of fine-tuned positioning.

In some embodiments, the arrangement of teeth 122 includes a variable depth pattern, such as teeth of various heights and/or depths. For instance, teeth along the first toothed surface 124a and/or the second toothed surface 124b alternate between relatively shallow and relatively deep teeth, which in an example provides multi-level engagement options for enhanced positional stability. In various examples, the arrangement of teeth 122 includes one or more regions along a length of the first toothed surface 124a and/or the second toothed surface 124b with different tooth patterns, e.g., one or more of a uniform, non-uniform, graduated, variable depth, etc.

For example, the first toothed surface 124a and the second toothed surface 124b include a first region with a uniform spacing, a second region with a non-uniform spacing, and a third region with a variable depth configuration to achieve a variety of functionality depending on which region engages with the vertical toothblock pin 104. In at least one example, the first toothed surface 124a and the second toothed surface 124b are dissimilar, e.g., include different tooth configurations, patterns, and/or spacing. In this way, the diverse tooth spacing described herein supports varying degrees of positional adjustment.

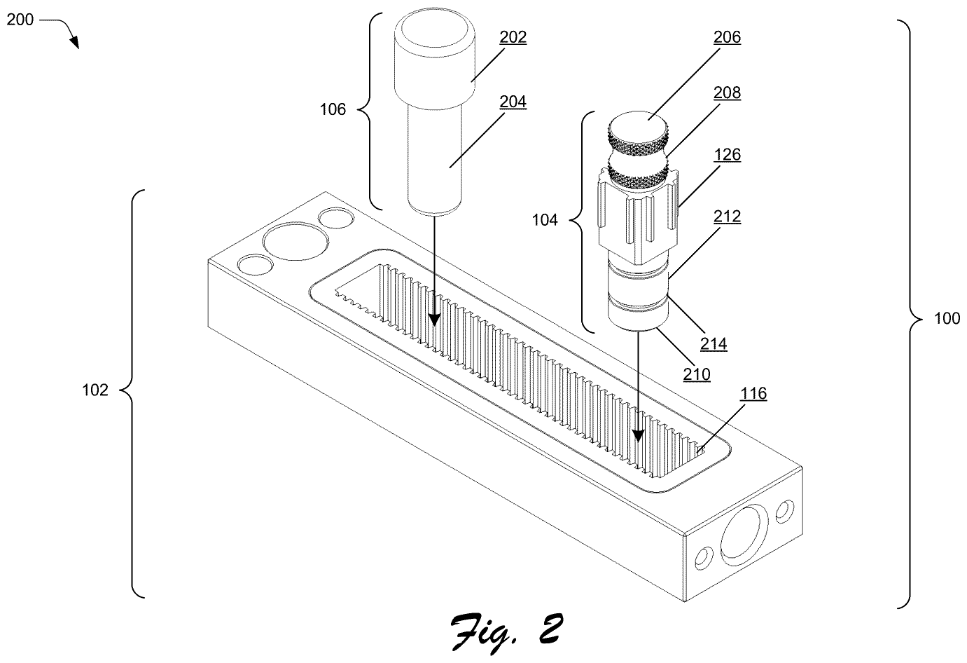

FIG. 2 depicts a view 200 of the block assembly 100 with the block body 102, vertical toothblock pin 104, and the pin 106 disengaged from one another in accordance with one or more implementations. In this example, the pin 106 is insertable through the toothed pin slot 116, such as without engaging with the teeth 122, to affix the block assembly 100 to an adjacent surface. For instance, the pin 106 is inserted through the toothed pin slot 116 into an aperture of a gridded work table to attach the block body 102 to the work table.

The pin 106 is depicted to include a cylindrical head 202 that is connected to a cylindrical shaft 204. This is by way of example and not limitation, and a variety of shapes are considered for the head 202 and/or the shaft 204. The shaft 204 is dimensioned to pass through the toothed pin slot 116. For instance, the shaft 204 has a width (e.g., a diameter) less than a width of the toothed pin slot 116. The head 202 is dimensioned to contact the top surface 108 of the block body 102, such as with a width (e.g., a diameter) greater than the width of the toothed pin slot 116.

The vertical toothblock pin 104 is also insertable through the toothed pin slot 116 to affix the block assembly 100 to an adjacent surface and further secure the block assembly 100 in one or more positions and/or orientations. The vertical toothblock pin 104 includes a proximal end 206 that includes a pin head 208 and distal end 210 having a pin shaft 212. In the illustrated example, the pin head 208 includes a waisted cylindrical body (e.g., with a concave profile) that includes one or more gripped surfaces designed to facilitate user manipulation of the vertical toothblock pin 104.

The pin shaft 212 is depicted as a cylindrical body that is dimensioned to pass through the toothed pin slot 116. For instance, the shaft 204 has a width (e.g., a diameter) less than a width of the toothed pin slot 116. The pin shaft 212 further can include one or more cylindrical grooves 214. In an example, the one or more cylindrical grooves 214 can be fitted with one or more gaskets, such as to increase contact adhesion between one or more of the vertical toothblock pin 104, the block body 102, and/or an adjacent surface. While in this example the pin shaft 212 is depicted as a cylindrical body, this is by way of example and not limitation, and the pin shaft 212 can include a variety of shapes.

The multifaced pin collar 126 is disposed between the pin head 208 and the pin shaft 212 and includes two or more surfaces to engage with the toothed pin slot 116. For instance, the multifaced pin collar 126 includes two or more pairs of parallel sides that are configured to engage with the arrangement of teeth 122 of the toothed pin slot 116. In the illustrated example, the multifaced pin collar 126 has a rectangular cross section, and thus has two pairs of substantially parallel sides. This is by way of example and not limitation, and a variety of shapes for the multifaced pin collar 126 are considered, as further described below.

Further, in various examples the multifaced pin collar 126 is removable from the pin shaft 212, and as such is interchangeable with one or more additional multifaced pin collars 126, such as to provide different teeth configurations for use by the block assembly 100. In one example, the vertical toothblock pin 104 includes a first mounting interface and the multifaced pin collar 126 includes a second mounting interface configured to engage with the first mounting interface to attach the multifaced pin collar to the vertical toothblock pin 104.

A variety of suitable mounting interfaces are considered. In one example, a shaft of the vertical toothblock pin 104 includes a threaded portion to form the first mounting interface and the multifaced pin collar 126 includes a tapped aperture dimensioned to correspond to the threaded portion to form the second mounting interface. In additional or alternative implementations, one or more of the first mounting interface or second mounting interface include a locking spring pin to facilitate efficient attachment and/or removal of the multifaced pin collar 126. The first mounting interface and/or the second mounting interface may further include one or more circumferential grooves, O-rings, magnetic inserts, etc. to attach and/or remove the multifaced pin collar 126 from the vertical toothblock pin 104.

Each pair of parallel sides of the multifaced pin collar 126 includes a tooth configuration that is dimensioned to engage with the arrangement of teeth 122 of the toothed pin slot 116. Accordingly, the tooth configurations of the multifaced pin collar 126 can have one or more uniform, non-uniform, graduated spacing, and/or variable depth configurations to correspond to the arrangement of teeth 122. Further, as described in the following examples, the tooth configurations of the multifaced pin collar 126 can be offset from one another, such as to position the vertical toothblock pin 104 within the toothed pin slot 116 at offset increments and thus position the block assembly 100 at various positions on a work surface.

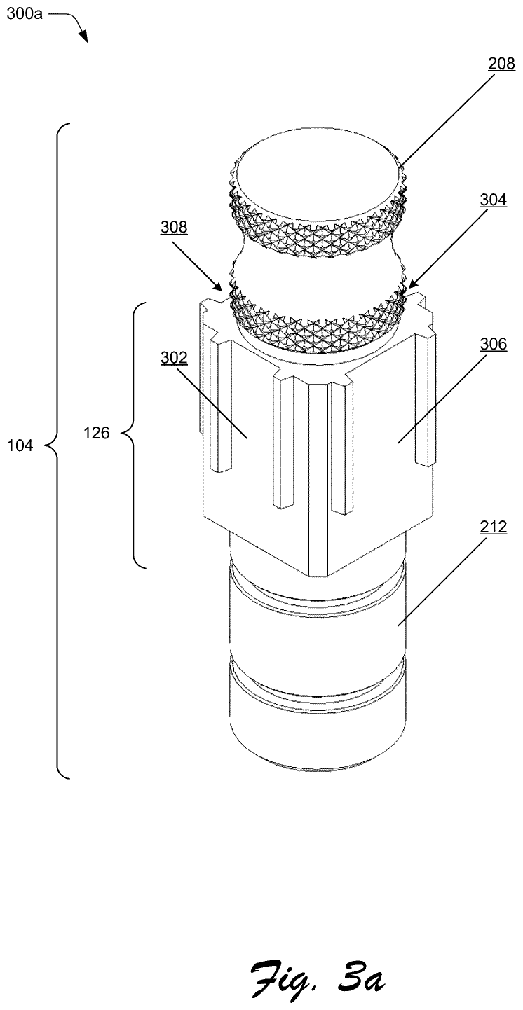

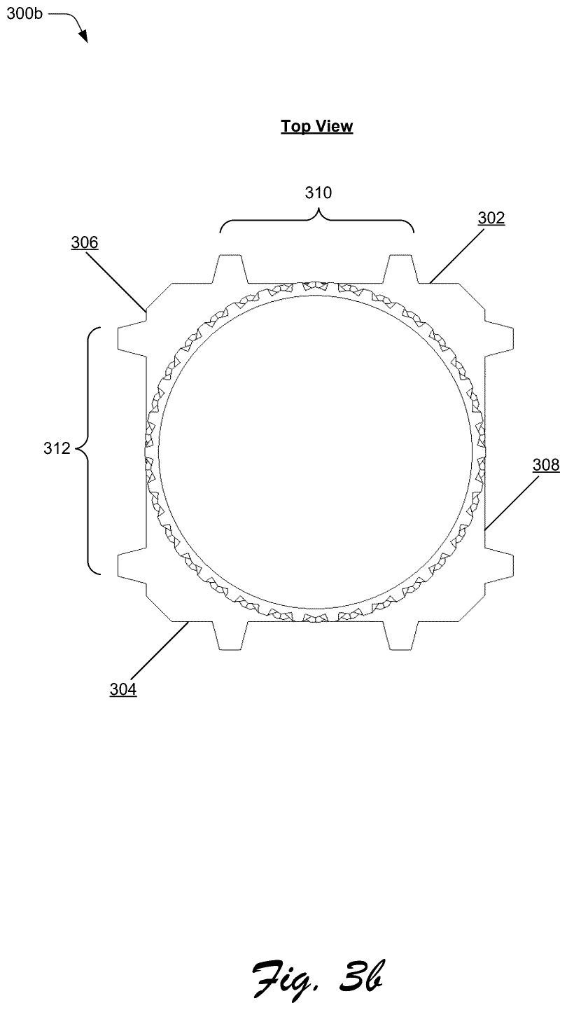

FIG. 3a depicts a view 300a of the vertical toothblock pin 104 in accordance with one or more implementations. In the illustrated example, the multifaced pin collar 126 is a rectangular prism disposed between the pin head 208 and the pin shaft 212 that includes a first face 302, a second face 304, a third face 306, and a fourth face 308. The first face 302 and the second face 304 form a first pair of substantially parallel sides that includes a first tooth configuration. The third face 306 and the fourth face 308 form a second pair of substantially parallel sides that includes a second tooth configuration.

FIG. 3b depicts a view 300b of the vertical toothblock pin 104 from above in accordance with one or more implementations. The view 300b, for instance, is a top view of the vertical toothblock pin 104 depicted in FIG. 3a. Continuing with the above example, the first tooth configuration of the first pair of substantially parallel sides includes four teeth, e.g., two teeth on the first face 302 and two teeth on the second face 304. In this example, the first face 302 and the second face 304 have a similar or same tooth arrangement, e.g., a similar or same number of teeth and spacing between adjacent teeth. However in some examples a tooth arrangement differs between individual faces of a pair of parallel sides. For instance, the tooth arrangement of the first face 302 may differ from the tooth arrangement of the second face 304.

The second tooth configuration of the second pair of substantially parallel sides also includes four teeth, e.g., two teeth on the third face 306 and two teeth on the fourth face 308. In this example, the third face 306 and the fourth face 308 have a similar or same tooth arrangement with a similar number and spacing of teeth. The teeth of both the first tooth configuration and the second tooth configuration in this example are dimensioned to coincide with “valleys” of the arrangement of teeth 122 of the toothed pin slot 116, e.g., the gaps between adjacent teeth.

However, the second tooth configuration differs from the first tooth configuration in that a positioning of the respective teeth and a spacing between respective teeth is different. For instance, a first distance 310 between adjacent teeth on the first face 302 is less than a second distance 312 between adjacent teeth on the third face 306. Accordingly, engagement of the first tooth configuration with the arrangement of teeth 122 positions the vertical toothblock pin 104 within the toothed pin slot 116 at a location offset from a location of the vertical toothblock pin 104 during engagement of the second tooth configuration with the arrangement of teeth 122. The offset distance, for instance, is less than a distance between adjacent teeth and/or valleys of the toothed pin slot 116.

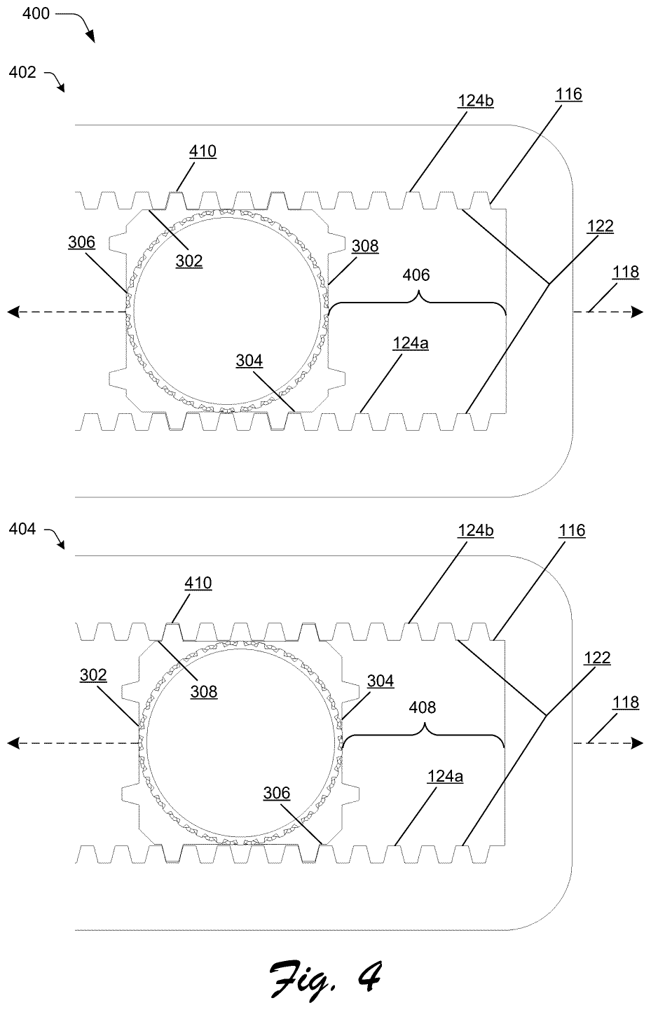

For instance, FIG. 4 depicts an example scenario 400 of engagement of the vertical toothblock pin 104 with the toothed pin slot 116 in accordance with one or more implementations in a first example 402 and a second example 404. In the first example 402, the vertical toothblock pin 104 is positioned such that the first tooth configuration is engaged with the arrangement of teeth 122 of the toothed pin slot 116. For instance, the teeth of the first face 302 are disposed within valleys between adjacent teeth located on the second toothed surface 124b while teeth of the second face 304 are disposed within valleys between adjacent teeth of the first toothed surface 124a.

In this example, the arrangement of teeth 122 has a spacing of ⅛ of an inch. Accordingly, adjusting the vertical toothblock pin 104 such that the teeth of the first tooth configuration engage with an adjacent valley of the arrangement of teeth 122 repositions the vertical toothblock pin 104 by ⅛ of an inch along the longitudinal axis 118. Accordingly, the vertical toothblock pin 104 can be positioned at increments of ⅛ of an inch using the first tooth configuration of the vertical toothblock pin 104. That is, the first tooth configuration provides a first set of possible positions of the vertical toothblock pin 104 within the toothed pin slot 116.

In the second example 404, the vertical toothblock pin 104 is positioned such that the second tooth configuration is engaged with the arrangement of teeth 122 of the toothed pin slot 116. For instance, the vertical toothblock pin 104 has been rotated counterclockwise 90 degrees and repositioned within the toothed pin slot 116 such that the teeth of the third face 306 are disposed within valleys between adjacent teeth located on the first toothed surface 124a while teeth of the fourth face 308 are disposed within valleys between adjacent teeth of the second toothed surface 124b.

Similar to the first tooth configuration, the second tooth configuration can position the vertical toothblock pin 104 within the toothed pin slot 116 by increments of ⅛ the of an inch. However, the second tooth configuration is offset from the first tooth configuration to provide a second set of possible positions of the vertical toothblock pin 104 within the toothed pin slot 116. For instance, when engaged with the arrangement of teeth 122, the second tooth configuration positions the vertical toothblock pin 104 at an offset position relative to the positions attainable using the first tooth configuration.

For example, the second set includes positions offset by 1/16 the of an inch away from positions of the first set. In the illustrated example, for instance, a distance 406 is 1/16 the of an inch greater than a distance 408 despite engagement of the vertical toothblock pin 104 with a same valley 410 in the first example 402 and the second example 404. Accordingly, in this example use of the vertical toothblock pin 104 effectively doubles the number of attainable positions of the block assembly 100 when attached to an adjacent surface.

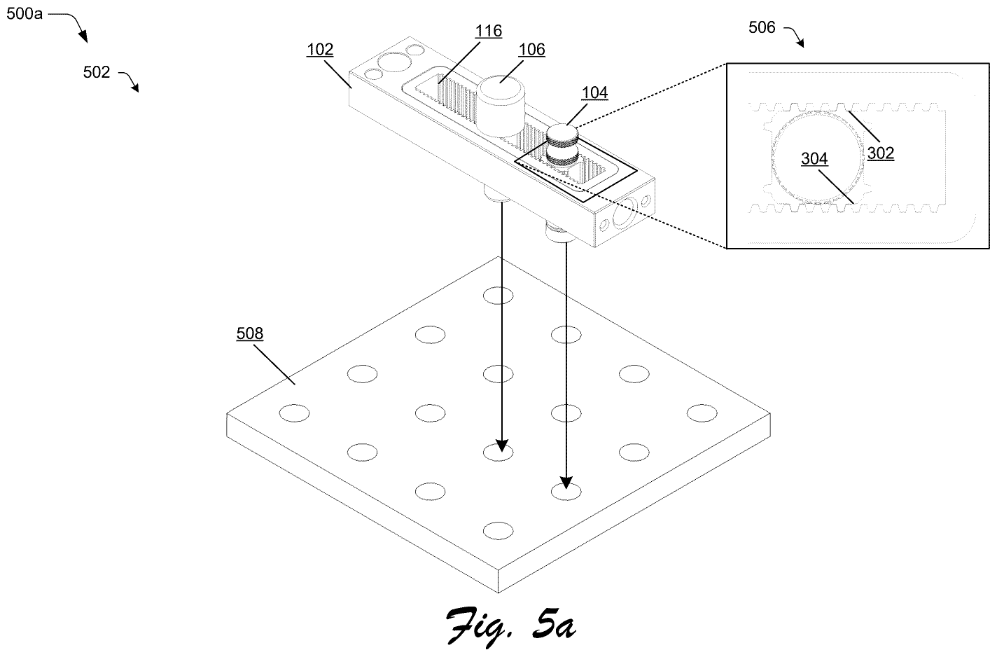

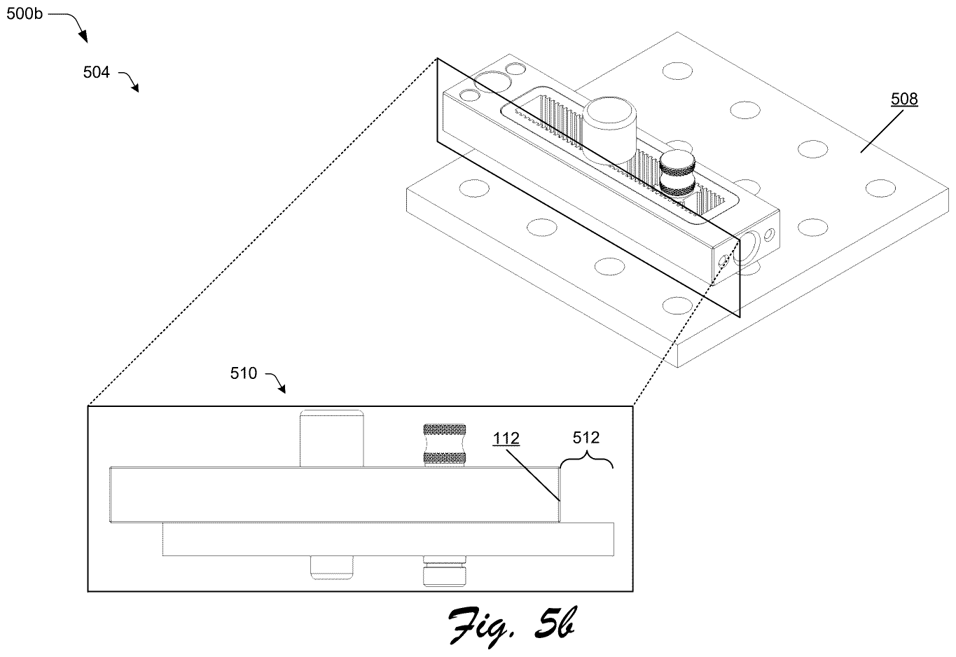

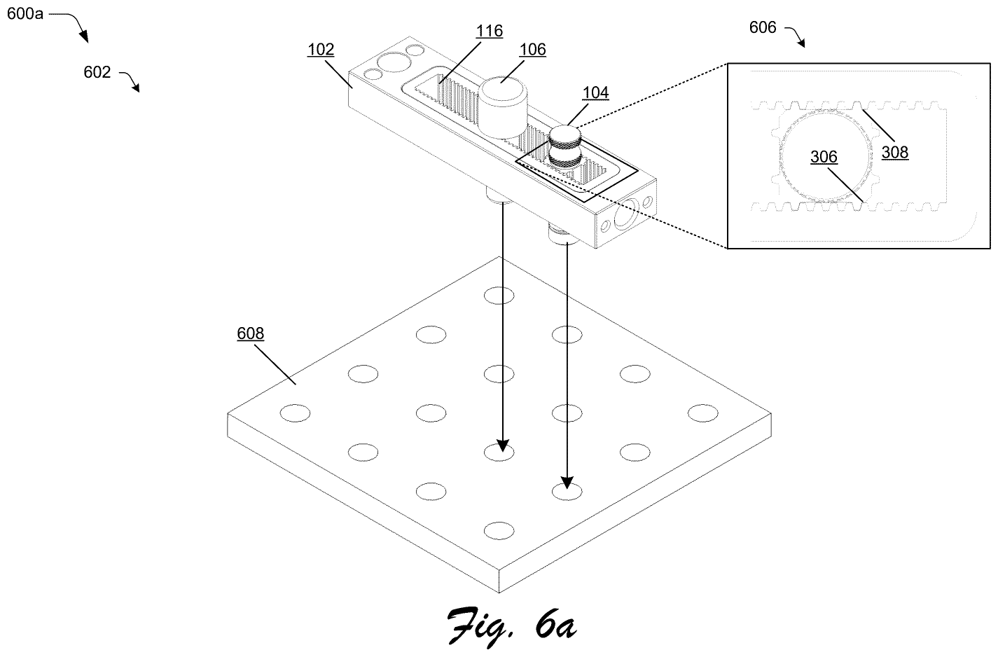

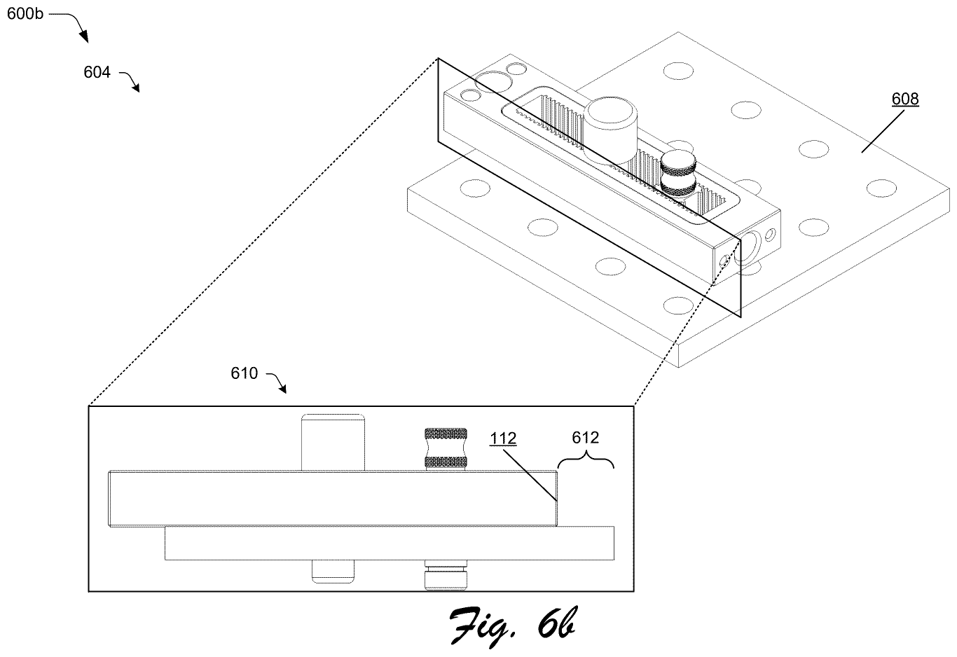

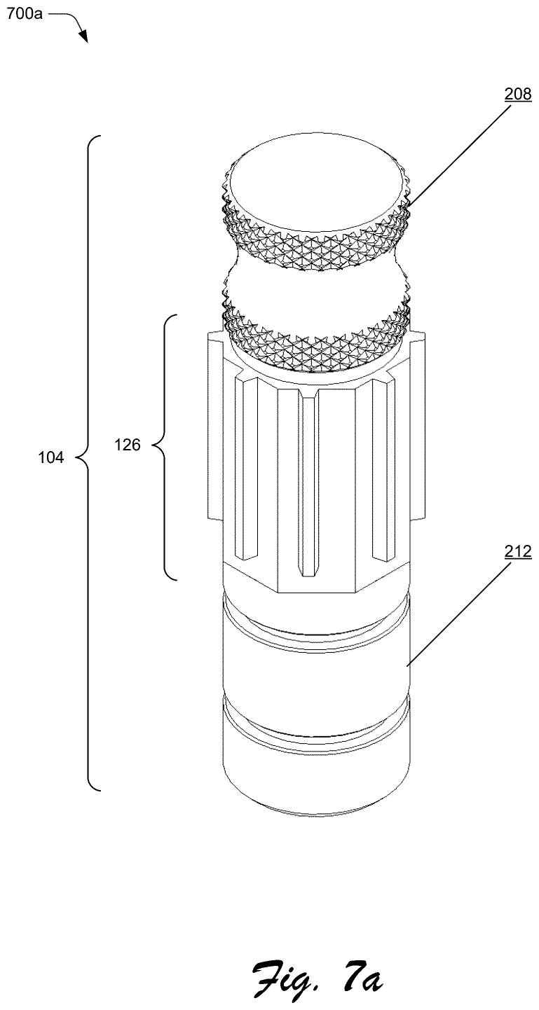

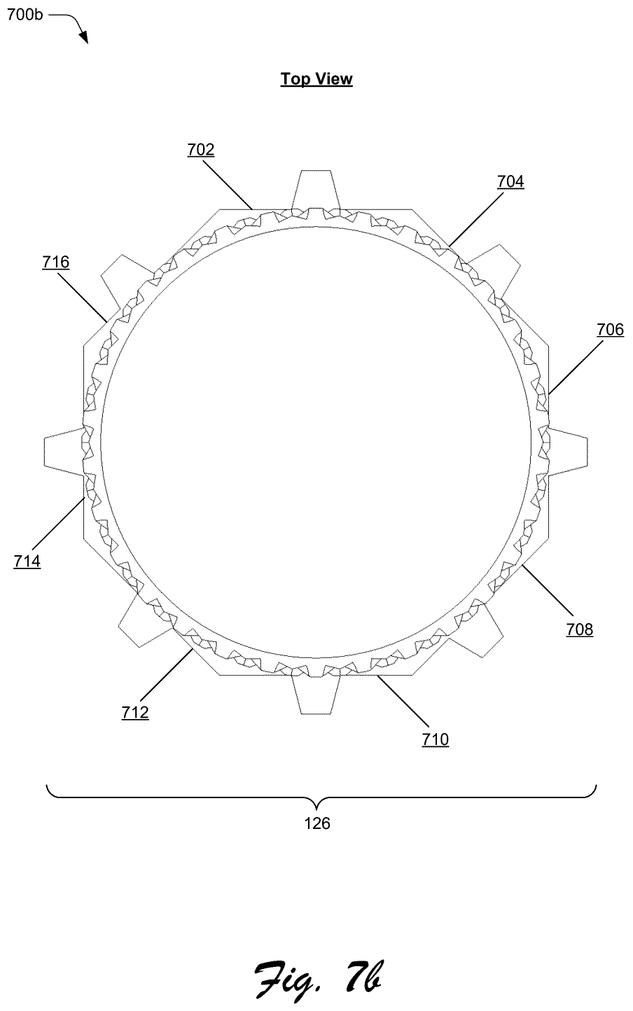

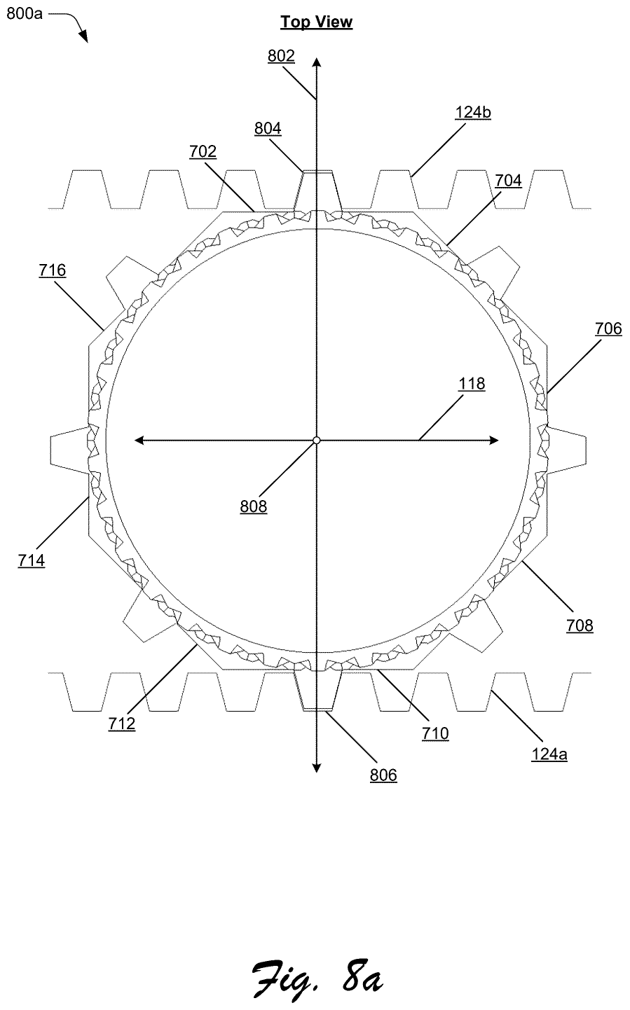

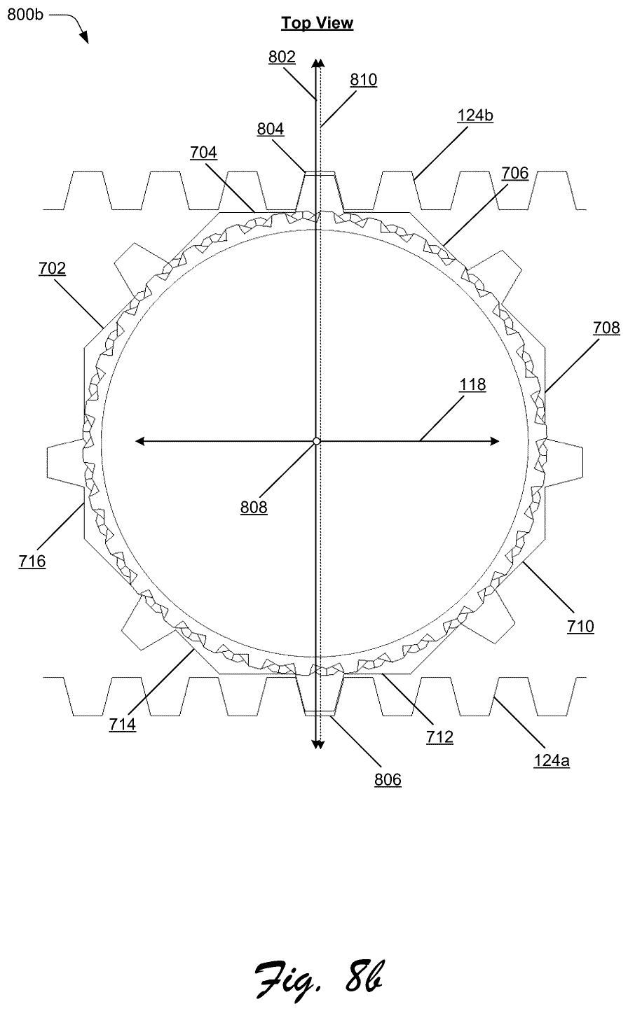

FIGS. 5a and 5b depict an example usage scenario 500a and 500b to use a configurable block assembly with the vertical toothblock pin 104 in a first position in accordance with one or more implementations in a first stage 502 and a second stage 504. As shown in the first stage 502, the pin 106 and the vertical toothblock pin 104 are disposed within the toothed pin slot 116 of the block body 102. As shown in the image inset 506, the vertical toothblock pin 104 is positioned such that the first tooth configuration is engaged with the arrangement of teeth 122. For instance, the teeth of the first face 302 are engaged with the second toothed surface 124b while teeth of the second face 304 are engaged with the first toothed surface 124a such as described above in the first example 402 of FIG. 4.

The pin 106 and the vertical toothblock pin 104 are dimensioned to coincide with apertures of a surface 508. The surface 508 is representative of a gridded worktable such as a welding table that includes cylindrical apertures with a fixed spacing, e.g., two inches between adjacent apertures. The block assembly 100 is attachable to the surface 508 via engagement (e.g., insertion) of the vertical toothblock pin 104 and the toothed pin slot 116 with the apertures of the surface 508.

As shown in second stage 504, for instance, the vertical toothblock pin 104 and the block body 102 have been inserted into apertures of the surface 508 to secure the block assembly 100 to the surface 508. As shown in the image inset 510, which depicts a side view of the block assembly 100 attached to the surface 508, the block assembly 100 is positioned at a first position relative to the surface 508. For instance, a first distance 512 represents a distance from the front surface 112 of the block body 102 to an end of the surface 508.

FIGS. 6a and 6b depict an example usage scenario 600a and 600b to use a configurable block assembly with the vertical toothblock pin 104 in a first position in accordance with one or more examples in a first stage 602 and a second stage 604. As shown in the first stage 602, the pin 106 and the vertical toothblock pin 104 are disposed within the toothed pin slot 116 of the block body 102. As shown in the image inset 606, the vertical toothblock pin 104 is positioned such that the second tooth configuration is engaged with the arrangement of teeth 122. For instance, the teeth of the third face 306 are engaged with the first toothed surface 124a while teeth of the fourth face 308 are engaged with the second toothed surface 124b such as described above in the second example 404 of FIG. 4.

The pin 106 and the vertical toothblock pin 104 are dimensioned to coincide with apertures of the surface 608. In an example, the surface 608 and the surface 508 represent the same surface. The block assembly 100 is attachable to the surface 608 via engagement of the vertical toothblock pin 104 and the toothed pin slot 116 with the apertures of the surface 508.

As shown in second stage 604, for instance, the vertical toothblock pin 104 and the block body 102 have been inserted into apertures of the surface 608 to secure the block assembly 100 to the surface 608. As shown in the image inset 610, which depicts a side view of the block assembly 100 attached to the surface 608, the block assembly 100 is positioned at a second position relative to the surface 608. For instance, a second distance 612 represents a distance from the front surface 112 of the block body 102 to an end of the surface 608.

While the vertical toothblock pin 104 and the pin 106 are inserted into the same apertures of the surfaces 508, 608 in FIGS. 5 and 6, the orientation of the vertical toothblock pin 104 results in a different position of the block assembly 100 relative to the surfaces 508, 608. For instance, engagement of the second tooth configuration with the arrangement of teeth 122 causes the block assembly 100 to be positioned an offset distance relative to the block assembly 100 when positioned via engagement of the first tooth configuration with the arrangement of teeth 122. For example, the first distance 512 is different than the second distance 612, such as smaller by 1/16 the of an inch. Accordingly, the techniques described herein enable discrete and accurate positioning of various block bodies.

FIG. 7a depicts a view 700a of the vertical toothblock pin 104 in which the multifaced pin collar 126 includes eight sides in accordance with one or more implementations. As described above, a variety of shapes and configurations of the multifaced pin collar 126 are considered. The multifaced pin collar 126, for instance, can be a polygon that has two opposing contact points (e.g., on opposing faces, intersections of faces, and/or vertices) to engage with the sides of the arrangement of teeth 122, e.g., with the first toothed surface 124a and the second toothed surface 124b.

Accordingly, in some examples the multifaced pin collar 126 is a prism that has a parallelogon cross-section. For instance, the vertical toothblock pin 104 includes two or more pairs of parallel sides, such as having a rectangular, hexagonal, octagonal, decagonal, dodecagonal, hexadecagonal, etc. cross-section. In various embodiments, the cross-section of the multifaced pin collar 126 is regular in that each side has a substantially equivalent length.

For instance, FIG. 7b depicts a top view 700b of the octagonal vertical toothblock pin 104 in accordance with one or more implementations. The view 700b, for instance, depicts a top view of the multifaced pin collar that is depicted in the view 700a. In the illustrated example, the multifaced pin collar 126 has an octagonal cross-section with four pairs of substantially parallel sides. Each pair of parallel sides has a tooth configuration that, when engaged with the arrangement of teeth 122, positions the vertical toothblock pin 104 within the toothed pin slot 116 at a unique location as further described below.

The multifaced pin collar 126 in the illustrated example includes a first face 702, a second face 704, a third face 706, a fourth face 708, a fifth face 710, a sixth face 712, a seventh face 714, and an eighth face 716. The first face 702 and the fifth face 710 form a first pair of parallel sides, the second face 704 and the sixth face 712 form a second pair, the third face 706 and the seventh face 714 form a third pair, and the fourth face 708 and the eighth face 716 form a fourth pair. Each pair has a unique tooth configuration that is able to position the vertical toothblock pin 104 within the toothed pin slot 116 at a unique location. For instance, when engaged with the arrangement of teeth 122, the first pair positions the vertical toothblock pin 104 within the toothed pin slot 116 at a first position, the second pair positions the toothed pin slot 116 at a second position, the third pair at a third position, and the fourth pair at a fourth position.

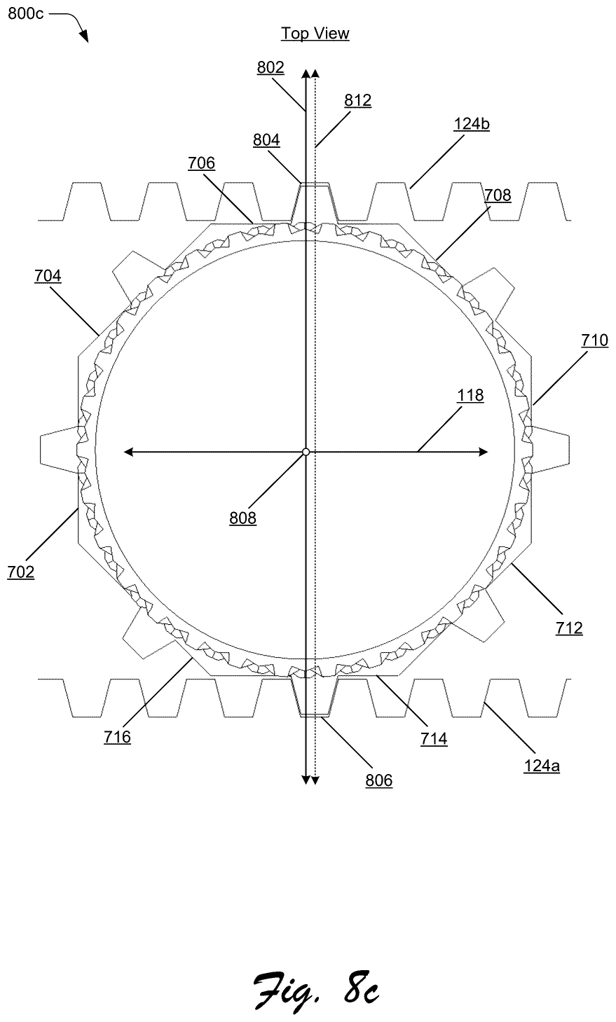

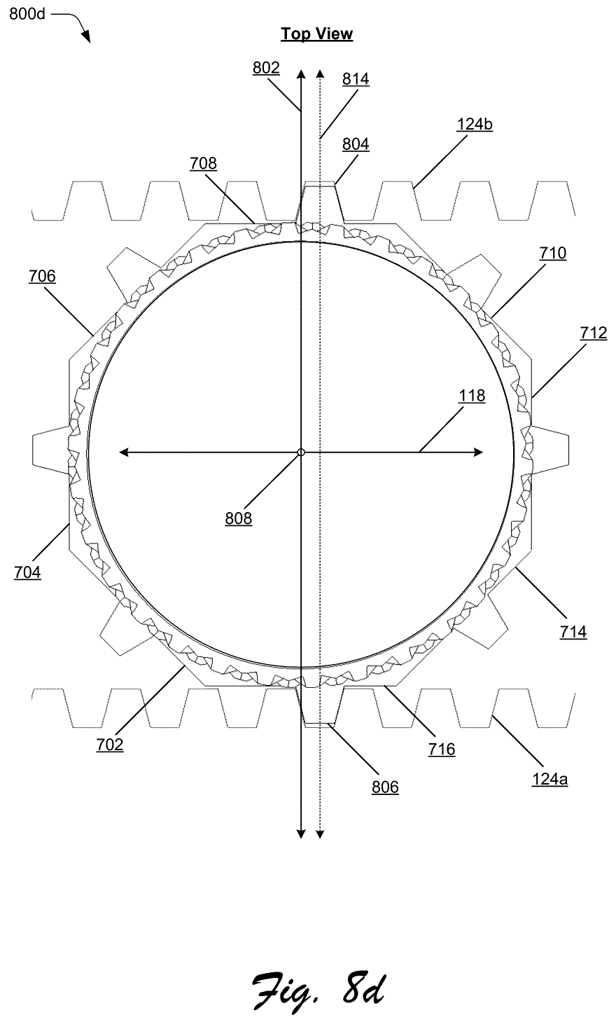

FIG. 8a depicts an example 800a of engagement of the first pair of parallel sides with the arrangement of teeth 122 in accordance with one or more implementations. For instance, the first face 702 includes a tooth that is engaged with a valley 804 of the second toothed surface 124b and the fifth face 710 includes a tooth that is engaged with a valley 806 the first toothed surface 124a. In this example, the first pair of parallel sides has a first tooth configuration that is centered, such as colinear with a central axis 802 of the vertical toothblock pin 104. Accordingly, in this configuration, a center 808 of the vertical toothblock pin 104 is aligned with a center of the teeth of the first face 702 and the fifth face 710 to position the vertical toothblock pin 104 at a first position along the longitudinal axis 118 within the toothed pin slot 116.

FIG. 8b depicts an example 800b of engagement of the second pair of parallel sides with the arrangement of teeth 122 in accordance with one or more implementations. In this example, the vertical toothblock pin 104 has been rotated counterclockwise 45 degrees such that the second tooth configuration of the second pair of parallel sides, e.g., the second face 704 and the sixth face 712, are in contact with the toothed pin slot 116. For instance, the second face 704 includes a tooth that is engaged with the valley 804 of the second toothed surface 124b and sixth face 712 includes a tooth that is engaged with a valley 806 the first toothed surface 124a.

The second tooth configuration is located a first offset distance from the center of the vertical toothblock pin 104, such as relative to the first tooth configuration. For instance, a dashed line depicts an axis 810 that represents a center of the second tooth configuration. The axis 810, for instance, represents a line between a midpoint of the tooth on the second face 704 and a midpoint of the tooth on the sixth face 712. As illustrated, the axis 810 is offset by the first offset distance from the axis 802, which is denoted with a solid line. Accordingly, in this configuration, a center of the vertical toothblock pin 104 is located at a second position that is the first offset distance from the first position.

FIG. 8c depicts an example 800c of engagement of the third pair of parallel sides with the arrangement of teeth 122 in accordance with one or more implementations. In this example, the vertical toothblock pin 104 has been rotated counterclockwise another 45 degrees (from the configuration depicted in FIG. 8b) such that the third tooth configuration of the third pair of parallel sides, e.g., the third face 706 and the seventh face 714, are in contact with the toothed pin slot 116. For instance, the third face 706 includes a tooth that is engaged with the valley 804 of the second toothed surface 124b and seventh face 714 includes a tooth that is engaged with a valley 806 the first toothed surface 124a.

The third tooth configuration is located a second offset distance from the center of the vertical toothblock pin 104. For instance, a dashed line depicts an axis 812 that represents a center of the third tooth configuration. The axis 812, for instance, represents a line between a midpoint of the tooth on the third face 706 and a midpoint of the tooth on the seventh face 714. As illustrated, the axis 812 is offset from the axis 802 by the second offset distance, which is denoted with a solid line. Accordingly, in this configuration, a center of the vertical toothblock pin 104 is located at a third position that is the third offset distance from the first position.

FIG. 8d depicts an example 800d of engagement of the fourth pair of parallel sides with the arrangement of teeth 122 in accordance with one or more implementations. In this example, the vertical toothblock pin 104 has been rotated counterclockwise an additional 45 degrees (from the configuration depicted in FIG. 8c) such that the fourth tooth configuration of the fourth pair of parallel sides, e.g., the fourth face 708 and the eighth face 716, are in contact with the toothed pin slot 116. For instance, the fourth face 708 includes a tooth that is engaged with the valley 804 of the second toothed surface 124b and eighth face 716 includes a tooth that is engaged with a valley 806 the first toothed surface 124a.

The fourth tooth configuration is located a third offset distance from the center 808 of the vertical toothblock pin 104. For instance, a dashed line depicts an axis 814 that represents a center of the fourth tooth configuration. The axis 814, for instance, represents a line between a midpoint of the tooth on the fourth face 708 and a midpoint of the tooth on the eighth face 716. As illustrated, the axis 814 is offset from the axis 802 by the third offset distance, which is denoted with a solid line. Accordingly, in this configuration, a center of the vertical toothblock pin 104 is located at a fourth position that is the third offset distance from the first position.

The second position, third position, and fourth position, for instance, are not attainable through engagement of the first tooth configuration alone, such as by repositioning of the vertical toothblock pin 104 to an adjacent valley of the toothed pin slot 116. Accordingly, the vertical toothblock pin 104 and the techniques described herein provide a modality to achieve precision in positioning block bodies in a variety of configurations, which is not possible in conventional approaches.

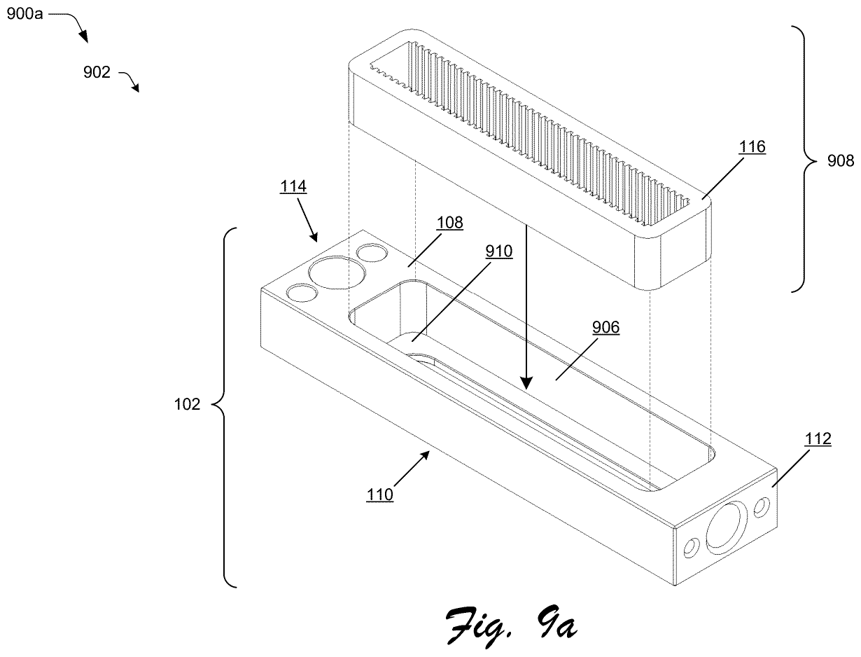

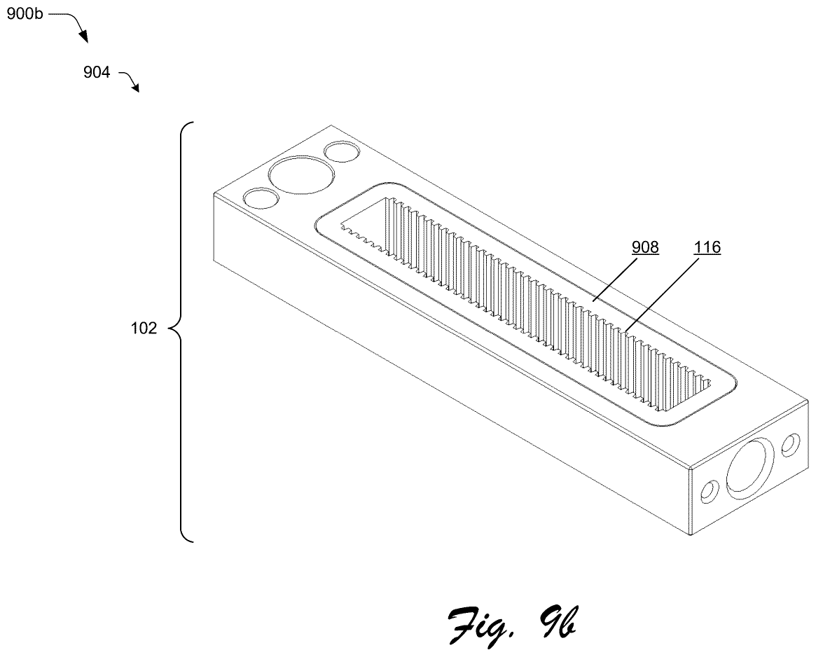

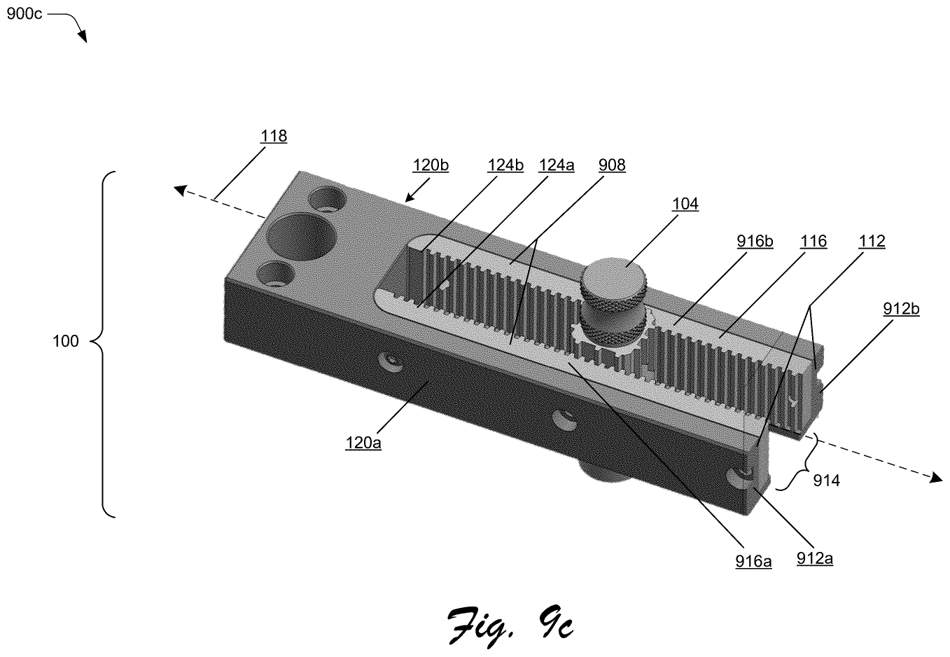

FIGS. 9a and 9b depict a scenario 900a, 900b in which the toothed pin slot 116 is included as part of a removable insert in accordance with one or more implementations in a first stage 902 and a second stage 904. In various examples, the toothed pin slot 116 may be included as part of the block body 102 such as machined (e.g., milled) into the block body 102. In this example, however, the toothed pin slot 116 is removable, such as to enable interchangeability of different toothed pin slots 116. In this way, the block body 102 can be configured to include various arrangements of teeth 122 with various patterns and/or spacing.

As shown in the first stage 902, the block body 102 includes a slot aperture 906 that is formed at least partially along the top surface 108 between the front surface 112 and the rear surface 114 and extending through an interior of the block body 102 to the bottom surface 110. The slot aperture 906 is dimensioned to house an insert 908 that includes the toothed pin slot 116. For instance, the slot aperture 906 is dimensionally complementary to the insert 908. In the illustrated example, the slot aperture 906 includes a stepped region 910 of a smaller dimension than the slot aperture 906. The stepped region 910 is dimensioned to allow the vertical toothblock pin 104 and/or the pin 106 to pass through, while securing the insert 908 within the slot aperture 906.

FIG. 9b depicts the block body 102 with the insert 908 in place. The insert 908 can be fastened into the slot aperture 906 utilizing any suitable attachment technique, such as using fasteners, adhesive, press fitting, interference fitting, magnets, one or more latches, spring pins, and so forth. In some examples, the insert 908 is removed and replaced with a different insert, such as an additional insert with a different arrangement of teeth 122. In this way, the block body 102 can be configured to include various arrangements of teeth 122 with various patterns and/or spacing.

In at least one example, the insert 908 includes a first removable tooth fitting and a second removable tooth fitting. For instance, FIG. 9c depicts an additional scenario 900c in which the insert 908 includes two or more removable tooth fittings and the front surface 112 includes two faces in accordance with one or more implementations. In various embodiments, one or more of the front surface 112 and/or the rear surface 114 includes two or more faces, such as with a gap disposed between a first face and a second face.

In the illustrated example, for instance, the front surface 112 includes a first front face 912a and a second front face 912b with a gapped region 914 between the first front face 912a and the second front face 912b. The first front face 912a, for instance, is disposed adjacent to the side surface 120a and the second front face 912b is disposed adjacent to the side surface 120b. The gapped region 914 has a width substantially similar to a width of the toothed pin slot 116. Accordingly, in this example the block body 102 has a “U-shaped” configuration such that the toothed pin slot 116 is not enclosed by a region of the front surface 112.

Further to the illustrated example, the insert 908 includes a first removable tooth fitting 916a that includes the first toothed surface 124a can be inserted into the slot aperture 906 and disposed on an internal surface of the slot aperture 906 proximal to the side surface 120a. In one example, the slot aperture 906 includes a first fitting cavity parallel to the longitudinal axis 118 to house the first removable tooth fitting 916a. The second removable tooth fitting 916b in this example includes the second toothed surface 124b and can be inserted into the slot aperture 906 and disposed on an internal surface of the slot aperture 906 proximal to the side surface 120b. The slot aperture 906, for instance, further includes a second fitting cavity parallel to the longitudinal axis 118 to house the second removable tooth fitting 916b. Any suitable fastening component and/or technique can be used to attach the first removable tooth fitting 916a and/or the second removable tooth fitting 916b to the slot aperture 906. In this way, each side of the insert 908 can be customized, such as for variable positioning of the vertical toothblock pin 104 within the toothed pin slot 116.

### Toothed Washer and Variable Width Pin Slot

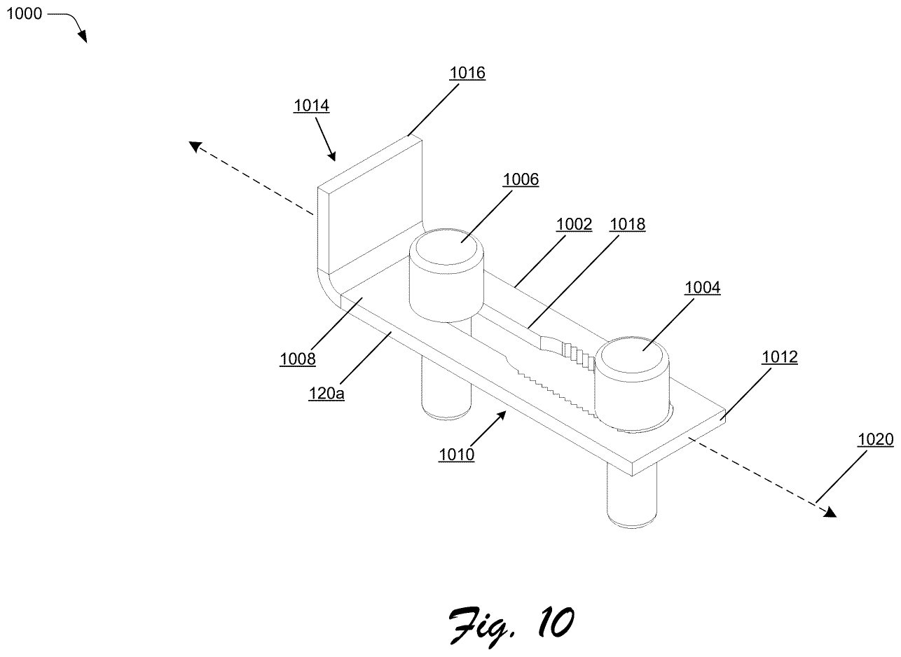

FIG. 10 depicts an implementation of a block assembly 1000 that includes a variable width pin slot in accordance with one or more implementations. In the illustrated example, the block assembly 1000, e.g., a configurable block assembly, includes a block body 1002, a vertical pin such as a first pin 1004, and a second pin 1006 engaged with one another. In various embodiments, the block body 1002 includes one or more properties of the block body 102, the first pin 1004 includes one or more properties of the vertical toothblock pin 104, and/or the second pin 1006 includes one or more properties of the pin 106. In at least one example, the block body 1002 is the block body 102, the first pin 1004 is the vertical toothblock pin 104, and/or the second pin 1006 is the pin 106.

The block body 1002 includes a top surface 1008, a bottom surface 1010, a front surface 1012, and a rear surface 1014. In this example, the rear surface 1014 includes a contact face 1016 that is formed substantially perpendicular to the top surface 1008. The contact face 1016, for instance, is configured to contact a workpiece, such as to secure the workpiece when affixed to a gridded worktable. While in this example the contact face 1016 is disposed on the rear surface 1014, it should be understood that one or more of the top surface 1008, bottom surface 1010, the front surface 1012, and/or the rear surface 1014 may include one or more contact faces 1016.

The block body 1002 further includes a variable width pin slot 1018 formed at least partially along the top surface 108 that extends through an interior of the block body 102 to the bottom surface 110. The variable width pin slot 1018, for instance, forms an extended slot extending along a longitudinal axis 1020 of the block body 1002. Pins, bolts, screws, etc., such as the first pin 1004 and/or the second pin 1006, can be placed through the variable width pin slot 1018 to secure the block body to an adjacent surface, such as a gridded work surface, e.g., a welding table.

In at least one example, the block body 1002 is manufactured using a single flat plate, e.g., a plate with a thickness within a range of 0.02 inches to 0.25 inches. The contact face 1016 is formed using any suitable method of manufacturing, such as by bending the flat plate to form the contact face 1016. The variable width pin slot 1018 can be formed from the flat plate using one or more techniques such as punching an aperture into the flat plate using a punch and die set, laser cutting, waterjet cutting, CNC milling, drilling, etc. By forming the block body 1002 from a single flat plate, the techniques described herein conserve resources and simplify manufacturing processes.

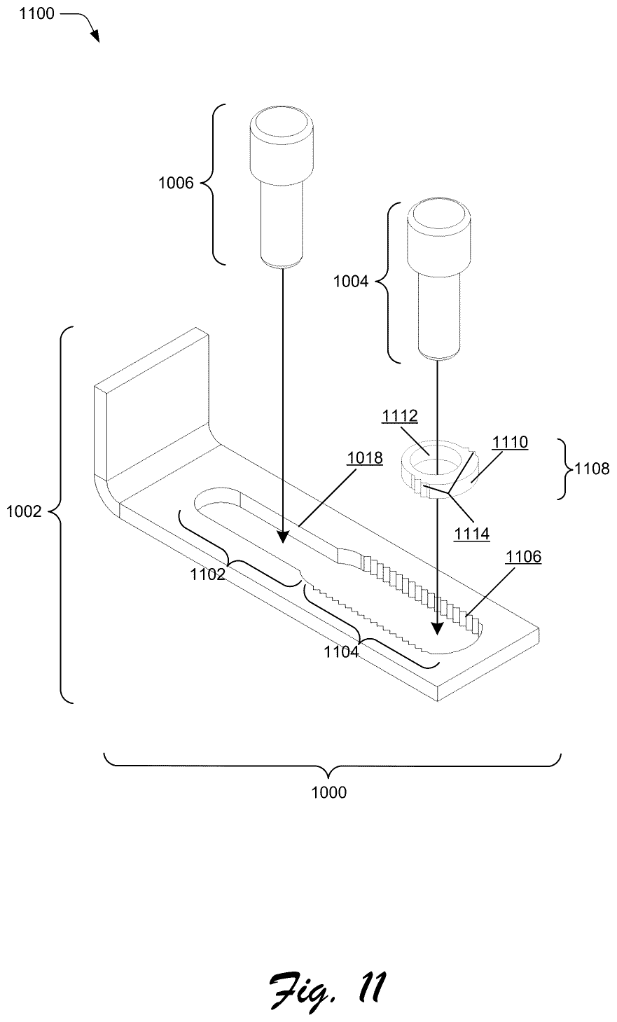

FIG. 11 depicts a view 1100 of the block assembly 1000 with the block body 1002, the first pin 1004, and the second pin 1006 disengaged from one another in accordance with one or more implementations. In this example, the variable width pin slot 1018 includes a first region 1102 of a first width and a second region 1104 of a second width. The second region 1104 includes an arrangement of teeth 1106 that extend inwardly to opposite sides of the variable width pin slot 1018. The arrangement of teeth 1106 can have a variety of tooth/valley patterns and/or spacing, such as one or more of the configurations as described above with respect to the arrangement of teeth 122.

The second pin 1006 is dimensioned to coincide with the first region 1102 of the variable width pin slot 1018 such that the second pin 1006 can be inserted through the first region 1102 to secure the block body 1002 to an adjacent surface. The first region 1102, for instance, has a width that is dimensionally complementary to a shaft of the second pin 1006 (e.g., the width is slightly wider than a diameter of the shaft) and is smaller than a diameter of a head of the second pin 1006. In some examples, the second pin 1006 is freely movable along the longitudinal axis 1020 once inserted into the first region 1102.

In this example, the block assembly 1000 further includes a toothed washer 1108. In some implementations, the toothed washer 1108 represents a multifaced pin collar 126 that has been removed from a vertical toothblock pin 104. The toothed washer 1108 is dimensioned to coincide with the second region 1104 of the variable width pin slot 1018. For instance, the toothed washer 1108 includes an outer surface 1110 and an inner surface 1112. The inner surface 1112 is defined by an aperture, for instance an aperture dimensioned to coincide with a shaft of the first pin 1004. In some examples, the inner surface 1112 further includes a mounting interface, such as to attach to a corresponding mounting interface of the first pin 1004.

The outer surface includes a tooth configuration 1114 that in this example is disposed on opposite sides of the outer surface 1110. For instance, the tooth configuration 1114 includes a first toothed region at a location on a circumference of the outer surface 1110 and a second toothed region at an opposite location on the circumference, e.g., located a distance substantially equivalent to a diameter of the outer surface 1110 away from the first toothed region. The tooth configuration 1114 is configured to engage with the arrangement of teeth 1106 of the variable width pin slot 1018. Thus, a variety of tooth patterns, spacings, and configurations are contemplated for the tooth configuration 1114. In this way, the first pin 1004 can be inserted into the aperture of the toothed washer 1108 such as to affix the block assembly 1000 to an adjacent surface and further secure the block assembly 1000 in one or more positions and/or orientations.

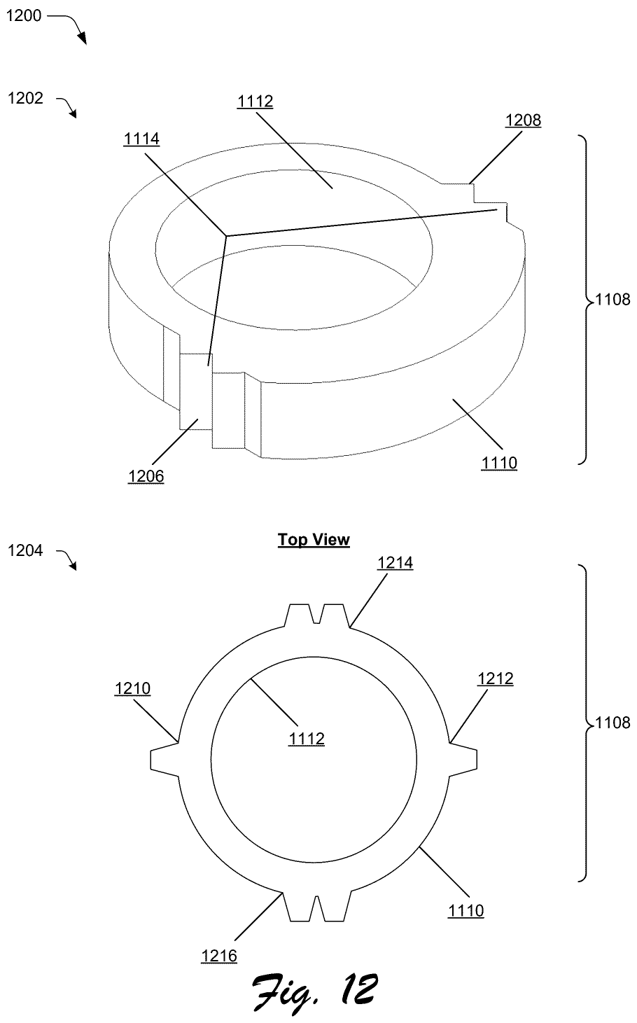

FIG. 12 depicts a view 1200 of example toothed washers 1108 in accordance with one or more implementations in a first example 1202 and a second example 1204. The first example 1202 depicts a close up view of the toothed washer 1108 such as described in FIG. 11. Accordingly, in this example the tooth configuration 1114 includes a first toothed region 1206 and a second toothed region 1208. For instance, the first toothed region 1206 includes two teeth and the second toothed region 1208 also includes two teeth. As illustrated, the second toothed region 1208 is located on an opposite side of the outer surface 1110 as the first toothed region 1206.

The teeth of the tooth configuration 1114 are configured to coincide with valleys of the arrangement of teeth 1106 to position the toothed washer 1108 within the variable width pin slot 1018. In this way, the first pin 1004 can be inserted into the aperture of the toothed washer 1108 to affix the block assembly 1000 to an adjacent surface. In at least one example, the toothed washer 1108 is representative of the multifaced pin collar 126 as described above. For instance, the toothed washer 1108 is an example of the multifaced pin collar 126 removed from the pin shaft 204. Accordingly, different toothed washers 1108 with different teeth configurations and patterns can be “swapped out” such as to achieve a variety of positioning within the variable width pin slot 1018.

The second example 1204 depicts a top view of a toothed washer 1108 that includes an additional tooth configuration located on different opposite sides of the outer surface 1110. For instance, the toothed washer 1108 includes a first tooth configuration (e.g., with two teeth) that includes teeth located on a first side 1210 and a second side 1212. As illustrated, the first side 1210 and the second side 1212 are located on opposite sides of the circumference of the outer surface 1110.

The toothed washer 1108 further includes a second tooth configuration (e.g., with four teeth) that includes teeth located on a third side 1214 and a fourth side 1216. As illustrated, the third side 1214 and the fourth side 1216 are located on different opposite sides of the circumference of the outer surface 1110 than the first side 1210 and the second side 1212. For instance, the first side 1210, second side 1212, third side 1214, and fourth side 1216 are located at 0°, 90°, 180°, and 360° of the circumference of the outer surface 1110.

Engagement of the toothed washer 1108 with the arrangement of teeth 1106 using the first tooth configuration provides a first set of attainable positions of the toothed washer 1108 within the second region 1104. For instance, the toothed washer 1108 is positionable at a first set of increments using the first tooth configuration. Engagement of the toothed washer 1108 with the arrangement of teeth 1106 using the second tooth configuration provides a second set of increments, e.g., a second set of attainable positions of the toothed washer 1108 within the second region 1104. For instance, the second tooth configuration positions the toothed washer 1108 at an offset position relative to the positions attainable using the first tooth configuration.

The tooth configurations for the toothed washer 1108 depicted in FIG. 12 are by way of example and not limitation, and a variety of tooth configurations, patterns, and spacing are considered. For instance, the toothed washer 1108 may include additional tooth configurations located on opposite sides of the outer surface 1110, such as three, four, five, etc. tooth configurations. In such examples, the tooth configurations are dimensioned to engage with the arrangement of teeth 1106 to position the toothed washer 1108 at various positions within the variable width pin slot 1018. Thus, the techniques and configurable block assemblies described herein provide modalities to achieve precision positioning to achieve a variety of working scenarios.

Generally, the various structures discussed herein such as block bodies and toothed surfaces and features are combinable in various ways including implementations not expressly illustrated herein to provide for a variety of different adjustable length block assemblies.

### CONCLUSION

Accordingly, configurable block assembly and techniques are described. The block assemblies are usable to ensure precise and durable alignment of various workpieces while providing access for performing attachment and/or other work techniques thereon, which is not possible using conventional tools and techniques.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention. Additional aspects of the techniques, features, and/or methods discussed herein relate to one or more of the following:

In some aspects, the techniques described herein relate to a configurable block assembly including: a block body including a top surface, a bottom surface, at least one front surface and a rear surface, the block body including a toothed pin slot formed at least partially along the top surface between the at least one front surface and the rear surface and extending through an interior of the block body to the bottom surface, the toothed pin slot including an arrangement of teeth that extend inwardly and substantially perpendicular to opposing sides of the toothed pin slot; and a vertical toothblock pin including a multifaced pin collar, the multifaced pin collar having a pair of substantially parallel sides that includes a tooth configuration, the tooth configuration configured to engage with the arrangement of teeth of the toothed pin slot.

In some aspects, the techniques described herein relate to a configurable block assembly, wherein the vertical toothblock pin includes a proximal end and a distal end, the proximal end including a pin head and the distal end including a pin shaft, and wherein the multifaced pin collar is disposed between the pin head and the pin shaft.

In some aspects, the techniques described herein relate to a configurable block assembly, wherein the pin shaft is a cylindrical body and the multifaced pin collar is a regular prism with a parallelogon cross section.

In some aspects, the techniques described herein relate to a configurable block assembly, wherein the vertical toothblock pin includes an additional pair of substantially parallel sides that includes an additional tooth configuration, the additional tooth configuration further configured to engage with the arrangement of teeth of the toothed pin slot.

In some aspects, the techniques described herein relate to a configurable block assembly, wherein the additional tooth configuration is located an offset distance from a center of the vertical toothblock pin relative to the tooth configuration.

In some aspects, the techniques described herein relate to a configurable block assembly, wherein the vertical toothblock pin is positionable at a first position within the toothed pin slot by engagement of the tooth configuration of the pair of substantially parallel sides with the arrangement of teeth of the toothed pin slot and the vertical toothblock pin is positionable at a second position within the toothed pin slot by engagement of the additional tooth configuration of the additional pair of substantially parallel sides with the arrangement of teeth of the toothed pin slot, the second position located an offset distance from the first position, the offset distance less than a distance between adjacent teeth of the toothed pin slot.

In some aspects, the techniques described herein relate to a configurable block assembly, wherein the tooth configuration is defined by a first spacing between two teeth on each side of the pair of substantially parallel sides and the additional tooth configuration is defined by a second spacing between two teeth on each side of the additional pair of substantially parallel sides, the second spacing different from the first spacing.

In some aspects, the techniques described herein relate to a configurable block assembly, wherein the block body includes a slot aperture formed at least partially along the top surface between the at least one front surface and the rear surface and extending through an interior of the block body to the bottom surface, the slot aperture dimensioned to house an insert that includes the toothed pin slot.

In some aspects, the techniques described herein relate to a configurable block assembly, wherein the at least one front surface includes a first front face, a second front face, and a gapped region disposed between the first front face and the second front face, the gapped region having a width substantially similar to a width of the toothed pin slot such that the toothed pin slot is not enclosed by the at least one front surface.

In some aspects, the techniques described herein relate to a vertical toothblock pin insertable into a toothed pin slot of a block body, the vertical toothblock pin including: a proximal end having a pin head; a distal end having a pin shaft; and a multifaced pin collar disposed between the pin head and the pin shaft, the multifaced pin collar having a first pair of substantially parallel sides that includes a first tooth configuration and a second pair of substantially parallel sides that includes a second tooth configuration, the first tooth configuration and the second tooth configuration dimensioned to engage with the toothed pin slot to secure the vertical toothblock pin to the block body.

In some aspects, the techniques described herein relate to a vertical toothblock pin, wherein the first tooth configuration is defined by a first spacing between two teeth on each side of the first pair of substantially parallel sides and the second tooth configuration is defined by a second spacing between two teeth on each side of the second pair of substantially parallel sides, the second spacing different from the first spacing.

In some aspects, the techniques described herein relate to a vertical toothblock pin, wherein the first tooth configuration is dimensioned to position the vertical toothblock pin within the toothed pin slot at a first position and the second tooth configuration is dimensioned to position the vertical toothblock pin within the toothed pin slot at a second position, the second position located an offset distance from the first position.

In some aspects, the techniques described herein relate to a vertical toothblock pin, wherein the offset distance is less than a distance between adjacent teeth of the toothed pin slot.

In some aspects, the techniques described herein relate to a vertical toothblock pin, wherein the first tooth configuration includes a tooth colinear with a central axis of the vertical toothblock pin and the second tooth configuration includes a tooth located an offset distance from the central axis of the vertical toothblock pin.

In some aspects, the techniques described herein relate to a vertical toothblock pin, wherein the multifaced pin collar includes at least one additional pair of substantially parallel sides, the at least one additional pair of substantially parallel sides including at least one additional tooth configuration different from the first tooth configuration and the second tooth configuration.

In some aspects, the techniques described herein relate to a vertical toothblock pin, wherein the multifaced pin collar is removable from the vertical toothblock pin via disengagement of a first mounting interface of the vertical toothblock pin from a second mounting interface of the multifaced pin collar.

In some aspects, the techniques described herein relate to a configurable block assembly including: a block body including a top surface, a bottom surface, a front surface and a rear surface, the block body including a variable width pin slot formed at least partially along the top surface between the front surface and the rear surface and extending through an interior of the block body to the bottom surface, the variable width pin slot including a first region of a first width and a second region of a second width that includes an arrangement of teeth that extend inwardly to opposing sides of the variable width pin slot; and a toothed washer dimensioned to coincide with the second region of the variable width pin slot, the toothed washer including an outer surface and an inner surface, the inner surface defined by an aperture, the outer surface including a tooth configuration on opposite sides of the outer surface configured to engage with the arrangement of teeth of the variable width pin slot.

In some aspects, the techniques described herein relate to a configurable block assembly, further including a vertical pin dimensioned to coincide with the aperture of the toothed washer.

In some aspects, the techniques described herein relate to a configurable block assembly, further including an additional vertical pin dimensioned to coincide with the first region of the variable width pin slot.

In some aspects, the techniques described herein relate to a configurable block assembly, wherein the toothed washer includes an additional tooth configuration located on different opposing sides of the outer surface.

What is claimed is:

1. A configurable block assembly comprising:
a block body including a top surface, a bottom surface, at least one front surface and a rear surface, the block body including a toothed pin slot formed at least partially along the top surface between the at least one front surface and the rear surface and extending through an interior of the block body to the bottom surface, the toothed pin slot including an arrangement of teeth that extend inwardly and substantially perpendicular to opposing sides of the toothed pin slot; and
a vertical toothblock pin including a multifaced pin collar, the multifaced pin collar having a pair of substantially parallel sides that includes a tooth configuration, the tooth configuration configured to engage with the arrangement of teeth of the toothed pin slot.

2. The configurable block assembly as described in claim 1, wherein the vertical toothblock pin includes a proximal end and a distal end, the proximal end including a pin head and the distal end including a pin shaft, and wherein the multifaced pin collar is disposed between the pin head and the pin shaft.

3. The configurable block assembly as described in claim 2, wherein the pin shaft is a cylindrical body and the multifaced pin collar is a regular prism with a parallelogon cross section.

4. The configurable block assembly as described in claim 1, wherein the vertical toothblock pin includes an additional pair of substantially parallel sides that includes an additional tooth configuration, the additional tooth configuration further configured to engage with the arrangement of teeth of the toothed pin slot.

5. The configurable block assembly as described in claim 4, wherein the additional tooth configuration is located an offset distance from a center of the vertical toothblock pin relative to the tooth configuration.

6. The configurable block assembly as described in claim 4, wherein the vertical toothblock pin is positionable at a first position within the toothed pin slot by engagement of the tooth configuration of the pair of substantially parallel sides with the arrangement of teeth of the toothed pin slot and the vertical toothblock pin is positionable at a second position within the toothed pin slot by engagement of the additional tooth configuration of the additional pair of substantially parallel sides with the arrangement of teeth of the toothed pin slot, the second position located an offset distance from the first position, the offset distance less than a distance between adjacent teeth of the toothed pin slot.

7. The configurable block assembly as described in claim 4, wherein the tooth configuration is defined by a first spacing between two teeth on each side of the pair of substantially parallel sides and the additional tooth configuration is defined by a second spacing between two teeth on each side of the additional pair of substantially parallel sides, the second spacing different from the first spacing.

8. The configurable block assembly as described in claim 1, wherein the block body includes a slot aperture formed at least partially along the top surface between the at least one front surface and the rear surface and extending through an interior of the block body to the bottom surface, the slot aperture dimensioned to house an insert that includes the toothed pin slot.

9. The configurable block assembly as described in claim 1, wherein the at least one front surface includes a first front face, a second front face, and a gapped region disposed between the first front face and the second front face, the gapped region having a width substantially similar to a width of the toothed pin slot such that the toothed pin slot is not enclosed by the at least one front surface.

10. A vertical toothblock pin insertable into a toothed pin slot of a block body, the vertical toothblock pin comprising:
a proximal end having a pin head;
a distal end having a pin shaft; and
a multifaced pin collar disposed between the pin head and the pin shaft, the multifaced pin collar having a first pair of substantially parallel sides that includes a first tooth configuration and a second pair of substantially parallel sides that includes a second tooth configuration, the first tooth configuration and the second tooth configuration dimensioned to engage with the toothed pin slot to secure the vertical toothblock pin to the block body.

11. The vertical toothblock pin as described in claim 10, wherein the first tooth configuration is defined by a first spacing between two teeth on each side of the first pair of substantially parallel sides and the second tooth configuration is defined by a second spacing between two teeth on each side of the second pair of substantially parallel sides, the second spacing different from the first spacing.

12. The vertical toothblock pin as described in claim 10, wherein the first tooth configuration is dimensioned to position the vertical toothblock pin within the toothed pin slot at a first position and the second tooth configuration is dimensioned to position the vertical toothblock pin within the toothed pin slot at a second position, the second position located an offset distance from the first position.

13. The vertical toothblock pin as described in claim 12, wherein the offset distance is less than a distance between adjacent teeth of the toothed pin slot.

14. The vertical toothblock pin as described in claim 10, wherein the first tooth configuration includes a tooth colinear with a central axis of the vertical toothblock pin and the second tooth configuration includes a tooth located an offset distance from the central axis of the vertical toothblock pin.

15. The vertical toothblock pin as described in claim 10, wherein the multifaced pin collar includes at least one additional pair of substantially parallel sides, the at least one additional pair of substantially parallel sides including at least one additional tooth configuration different from the first tooth configuration and the second tooth configuration.

16. The vertical toothblock pin as described in claim 10, wherein the multifaced pin collar is removable from the vertical toothblock pin via disengagement of a first mounting interface of the vertical toothblock pin from a second mounting interface of the multifaced pin collar.

17. A configurable block assembly comprising:
a block body including a top surface, a bottom surface, a front surface and a rear surface, the block body including a variable width pin slot formed at least partially along the top surface between the front surface and the rear surface and extending through an interior of the block body to the bottom surface, the variable width pin slot including a first region of a first width and a second region of a second width that includes an arrangement of teeth that extend inwardly to opposing sides of the variable width pin slot; and
a toothed washer dimensioned to coincide with the second region of the variable width pin slot, the toothed washer including an outer surface and an inner surface, the inner surface defined by an aperture, the outer surface including a tooth configuration on opposite sides of the outer surface configured to engage with the arrangement of teeth of the variable width pin slot.

18. The configurable block assembly as described in claim 17, further comprising a vertical pin dimensioned to coincide with the aperture of the toothed washer.

19. The configurable block assembly as described in claim 18, further comprising an additional vertical pin dimensioned to coincide with the first region of the variable width pin slot.

20. The configurable block assembly as described in claim 17, wherein the toothed washer includes an additional tooth configuration located on different opposing sides of the outer surface.
